(19) United States
(12) Patent Application Publication
(10) Pub. No.: US 2026/0292562 A1
(43) Pub. Date: Sep. 24, 2026

(54) LOGGED MINIMIZATION OF DRIVE TEST

(71) Applicant: QUALCOMM Incorporated, San Diego, CA (US)

(72) Inventors: Tommy AZZINO, Jersey City, NJ (US); Navid ABEDINI, Basking Ridge, NJ (US); Junyi LI, Greentown, PA (US)

(21) Appl. No.: 19/083,319

(22) Filed: Mar. 18, 2025

(51) Int. Cl. H04W 24/10; H04W 76/27

(52) U.S. Cl. CPC H04W 24/10; H04W 76/27

(57) ABSTRACT

Certain aspects of the present disclosure provide techniques for wireless communications. An example method includes receiving, from a network entity, first signaling indicating one or more report triggering events for logged minimization of drive test (MDT) measurement reporting; establishing a radio resource control (RRC) connected state with the network entity based at least in part on the one or more report triggering events; and sending, to the network entity, first information comprising an indication of a logged MDT measurement report upon establishing the RRC connected state.

### INTRODUCTION

### Field of the Disclosure

Aspects of the present disclosure relate to wireless communications, and more particularly, to techniques for logged (minimization of drive test) MDT configurations and measurement reporting.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method of wireless communications by a user equipment (UE). The method includes receiving, from a network entity, first signaling indicating one or more report triggering events for logged minimization of drive test (MDT) measurement reporting; establishing a radio resource control (RRC) connected state with the network entity based at least in part on the one or more report triggering events; and sending, to the network entity, first information comprising an indication of a logged MDT measurement report upon establishing the RRC connected state.

Certain aspects provide a method of wireless communications by a network entity. The method includes sending, to a UE, first signaling indicating one or more report triggering events for logged MDT measurement reporting; receiving, from the UE, random access signaling to establish a RRC connected state with the UE; and receiving, from the UE, first information comprising an indication of a logged MDT measurement report upon establishing the RRC connected state.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a first example communications signaling for logged MDT configuration and measurement reporting.

FIG. 6 depicts a second example communications signaling for logged MDT configuration and measurement reporting.

FIG. 7 depicts a method for wireless communications.

FIG. 8 depicts another method for wireless communications.

FIG. 9 depicts aspects of an example communications device.

FIG. 10 depicts aspects of an example communications device.

### DETAILED DESCRIPTION

Aspects of the present disclosure provide apparatuses, methods, processing systems, and computer-readable mediums for logged minimization of drive test (MDT) configurations and measurement reporting.

Certain wireless communication systems may utilize MDT functionality, for example, rather than sending out technicians with sophisticated equipment to drive around and check the wireless network quality. While the wireless network quality information is important to a mobile network operator, the process of driving around and testing a large wireless communication system can be expensive and time consuming. Thus, mobile network operators may utilize a customer's user equipment (UE), or collectively UEs, such as mobile phones, consumer wireless devices, etc., to collect information indicating how well the wireless communication system is operating.

In certain aspects, MDT functionality may include logging information such as signal measurements (e.g., received signal strength, etc.) on a UE when the mobile phone is not actively being used. Then, when a user of the UE makes a call, sends a text, opens an app, or in some way activates the UE, the UE sends this logged MDT information to the network.

MDT functionality can improve performance in several ways. For example, MDT reports can help to pinpoint exactly where the wireless communication system is not performing well. Collectively, these MDT reports can provide a “heat map” type of representation of the wireless network quality issues across the entire coverage area of the wireless communication system, thereby enabling mobile network operators to focus their efforts on fixing specific trouble spots.

Based on these MDT reports, a mobile network operator can adjust various aspects of the wireless communication system. For example, the signal strength and beam direction of cells on cell towers, the handover parameters between adjacent cell towers, the frequency allocation to certain coverage areas, etc., may be adjusted based on these MDT reports. Moreover, by identifying areas where signal strength is too high and/or where unnecessary overlap between cell towers exists, a mobile network operator can optimize the wireless communication system to use less power while maintaining good coverage.

Additionally, traditional drive tests cannot easily measure wireless network quality indoors, but MDT functionality can enable this measurement opportunity. That is, for example, since an inactive phone may perform measurements and log information from wherever the phone is located, MDT measurement opportunities exist inside a building and other locations not readily accessible to traditional drive tests. Thus, MDT functionality can provide mobile network operators with a better understanding of the actual customer experience, thereby allowing mobile network operators to make their networks faster, more reliable, and more efficient.

However, conventional MDT procedures can be inefficient with respect to the signaling overhead of measurements reporting and memory utilization associated with logged MDT for a UE. The overhead associated with measurement reporting can be significant, for example, if the UE is configured with periodic logging of MDT measurements and a long duration of logging ensues. The UE may also include measurements from plural serving and neighboring cells in the logged MDT report. In addition, the logged MDT report may include synchronization signal block (SSB) information, which can increase the amount of additional data to be stored.

Logged MDT procedures in which measurements are reported when the UE becomes active again (e.g., transitions into connected state) may be inadequate for certain network reporting scenarios. That is, for example, once the UE starts the connection establishment procedure, the UE indicates that a logged MDT report is available. Without knowing what the logged MDT report contains or how long the UE has been logging measurement data, the network has to decide whether to obtain the logged MDT report from the UE. Moreover, the logged MDT report typically includes all of the previously logged measurements by the UE during the logging phase even if much of those previous measurements are not relevant to the network during the time at which the UE reconnects with the network.

Additionally, or alternatively, the logging of MDT measurements at the UE may fill a memory partition allocated and reserved for MDT purposes. If this memory partition is limited, it is beneficial that the UE fill the limited memory partition with meaningful MDT measurements that may be helpful to the network in assessing network performance, coverage analysis, outage detection, etc.

Various aspects described herein may overcome the aforementioned technical problems associated with conventional MDT functionality, for example, by providing techniques for logged MDT configurations and measurement reporting. In some aspects, a UE may receive signaling from a network entity that includes a logged MDT configuration. This signaling may include configuration information that indicates triggering events for logged MDT measurement reporting by the UE while performing MDT measurements in an idle or inactive mode.

For example, when the UE determines that one of these triggering events has occurred, the UE may exit the idle or inactive mode and immediately (or at the first opportunity) connect in an active mode with the network. The UE may send an indication of the availability of the logged MDT measurements to the network upon being actively connected with the network. In some cases, the triggering events may be related to the UE experiencing poor wireless network services conditions (e.g., an outage) or poor network planning conditions (e.g., excessive overlapping coverage areas).

In some aspects, a UE may receive signaling from the network entity that indicates logging triggering events for logged MDT measurement reporting. Logging triggering events may indicate specific events or conditions based on which the UE is triggered to log MDT measurements while operating in the idle or inactive mode. The specific events or conditions to trigger logging may be speed-based (e.g., speed thresholds), signal strength-based (e.g., signal thresholds from different networks), location-based (e.g., location detecting proximity to specific micro-areas), etc.

In some aspects, the indication of logged MDT measurements the UE sends to the network may indicate an event or condition that triggered the logged MDT measurement report. For example, rather than simply letting the network know that the UE has logged MDT measurements to report, the indication sent to the network may inform the network what type of event(s) and/or measurement information that the UE has to share. In some aspects, the network may prioritize retrieval of the logged MDT measurement report based on the indication provided by the UE. The UE may then receive such signaling from network.

In some aspects, a UE may provide delta measurement logging and reporting for MDT purposes. For example, the UE may utilize a reference log for particular types of measurements associated with logged MDT measurement reporting. The UE may measure a parameter configured for logged MDT measurement reporting. If the measurement is not within a configured threshold for the parameter, the UE may log the deviation between the measurement and a reference value for the parameter in the reference log. The reference value may be a known (or expected) measurement for a particular type of measurement of interest to the network. In some cases, the amount of deviation (e.g., a delta value of a particular measurement) may be logged as part of the logged MDT measurement report.

The techniques for logged MDT configurations and measurement reporting described herein may provide various beneficial technical effects and/or advantages. For example, the techniques for logged MDT configurations and measurement reporting may enable improved wireless network performance and network energy savings. By triggering logged MDT measurement reporting when the UE is experiencing poor wireless network service conditions, performance improvements may be realized, for example, by making coverage enhancements to the wireless network.

In some examples, by triggering logged MDT measurement reporting when the UE is experiencing poor network planning conditions, network energy saving may be realized, for example, by deactivating certain transmission beams and cells determined to have overlapping areas of coverage. This deactivation of transmission energy along with various other dynamic network energy saving initiatives are aided by logged MDT measurement reporting.

Additionally, or alternatively, the techniques for logged MDT configurations and measurement reporting may reduce signaling overhead and the required memory allocated and reserved for MDT purposes. By providing logging triggering events that indicate specific events or conditions for which the UE is to be triggered to log MDT measurements, more efficient logging of MDT measurements can be achieved, thereby resulting in better utilization of the memory resources of the UE.

This better utilization of memory resources may be of relevance for certain UE types that have limited memory resources in total and much less to reserve for MDT purposes. By achieving more efficient logging of measurements, more relevant measurements may be performed and/or signaling overhead associated with transmission of the logged MDT measurement reports may be reduced.

Additionally, or alternatively, by providing an indication of the event or condition that triggered the logged MDT measurement report, more efficient reporting of the MDT measurements can be achieved. Additionally, or alternatively, by providing the indication of the event or condition that triggered the logged MDT measurement report, signaling overhead associated with logged MDT reporting can be reduced, for example, by the network determining not to request the logged MDT measurement report that was triggered by the event or condition.

Moreover, by providing the indication of the event or condition that triggered the logged MDT measurement report, signaling overhead associated with logged MDT reporting can be reduced, for example, by the network determining to schedule transmission of the logged MDT measurement report by the UE during non-peak hours of wireless network activity. In some examples, by providing the indication of the event or condition that triggered the logged MDT measurement report, wireless network performance may be improved by the network prioritizing collection of measurement imperative to an immediate network condition.

Additionally, or alternatively, by providing delta measurement logging for MDT purposes, more efficient logging of MDT measurements can be achieved, for example, by reducing the occurrences for which the UE performs MDT measurement logging. Reducing the occurrences for which the UE performs MDT measurement logging results in better utilization of the memory resources of the UE. Additionally, or alternatively, by reducing the occurrences for which the UE performs MDT measurement logging, signaling overhead associated with logged MDT reporting can be reduced, for example, by reducing a size of the logged MDT measurement report that is signaled to the network.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

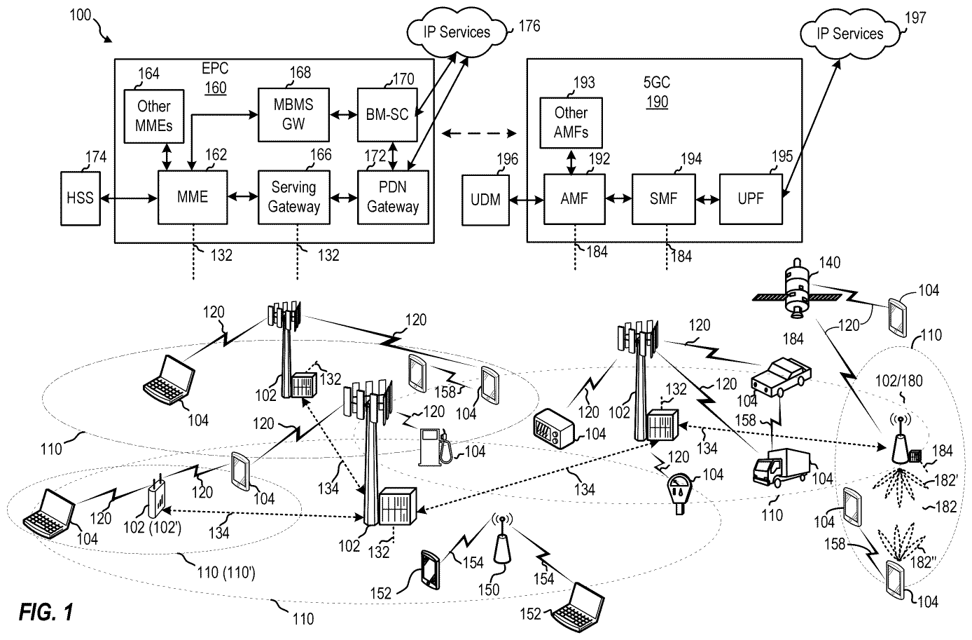

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

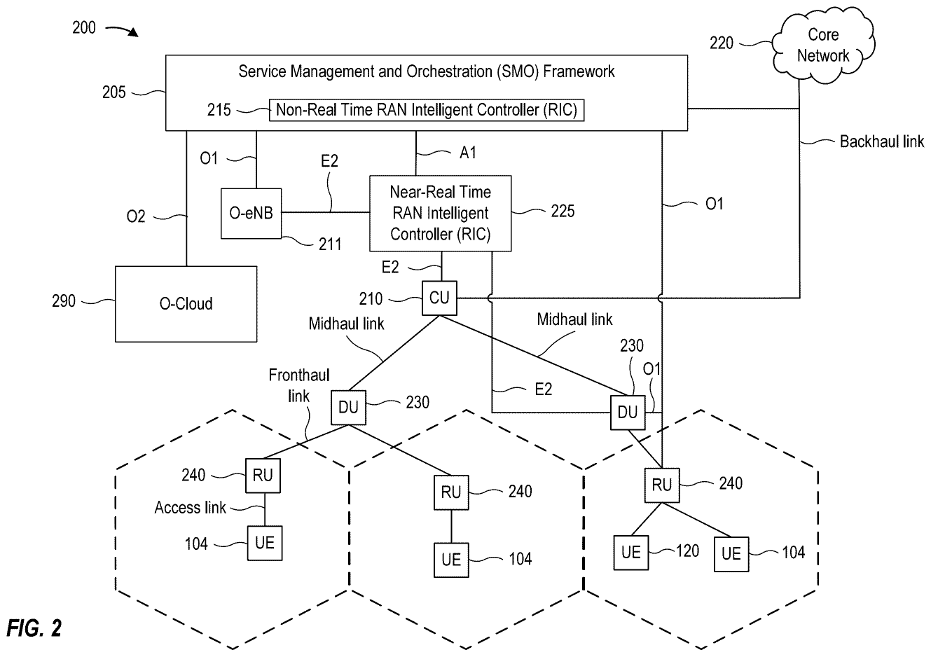

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz 71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182′′. UE 104 may also transmit a beamformed signal to the BS 180 in one or more transmit directions 182′′. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

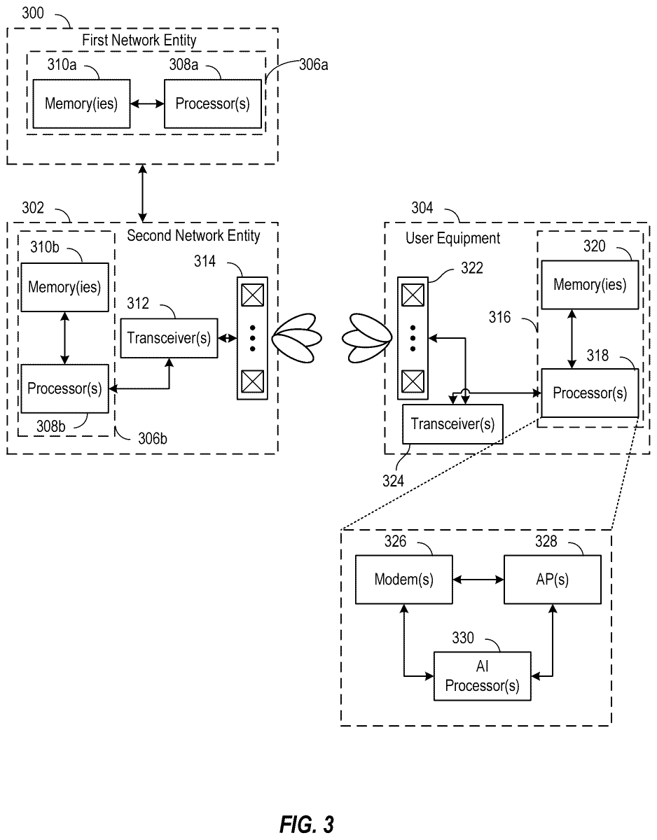

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

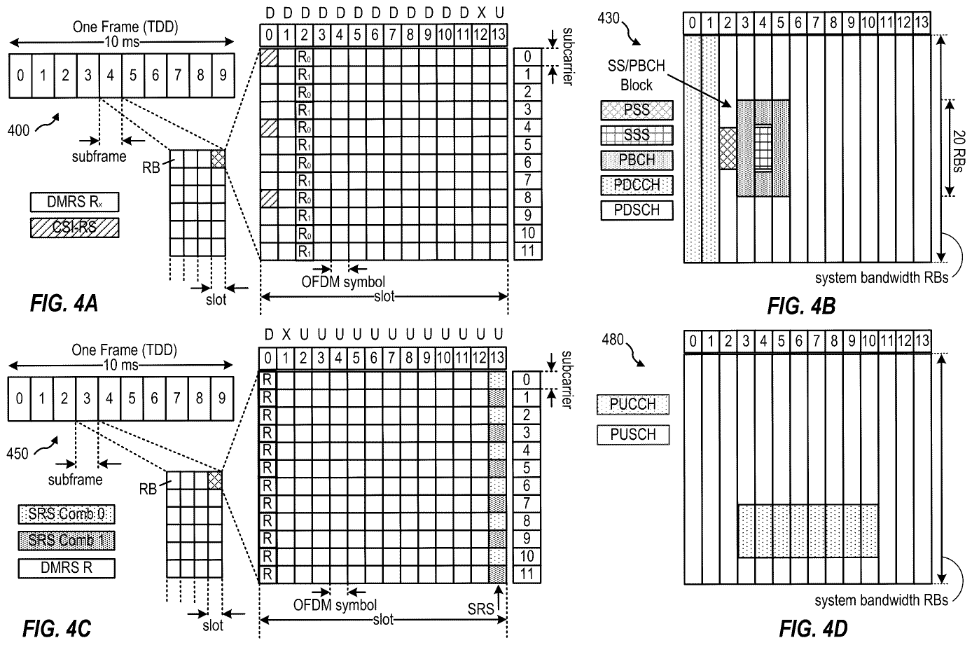

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ×}15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Logged MDT Configurations and Measurement Reporting

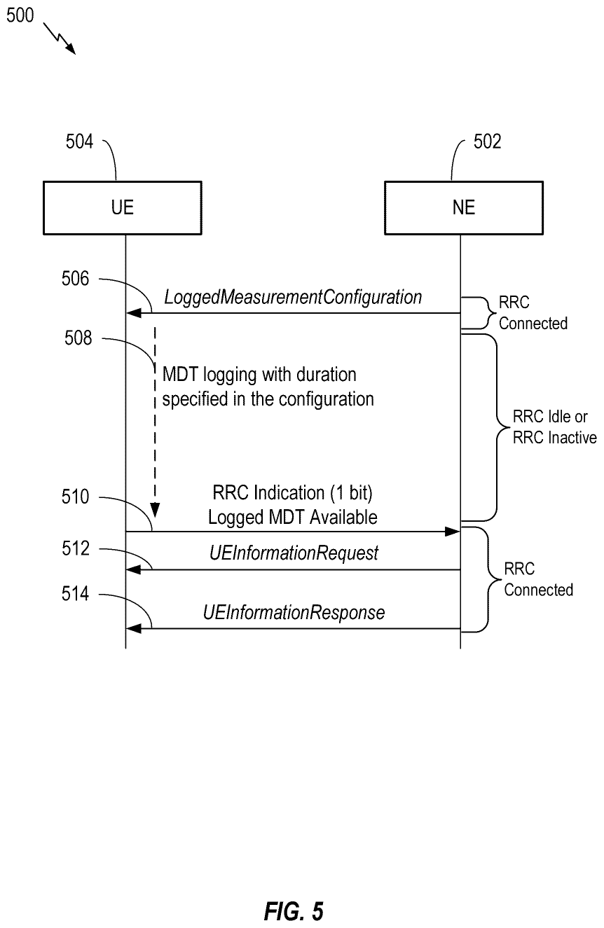

FIG. 5 depicts a first example communications signaling 500 for logged MDT configuration and measurement reporting. The first example communication signaling 500 may be between a network entity 502 and a UE 504. Certain aspects related to logged MDT configurations and measurement reporting may be implemented using the framework depicted in the first example communications signaling 500.

In some aspects, the network entity 502 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 504 may be an example of UE 104 depicted and described with respect to FIG. 1, or the UE 304 depicted and described with respect to FIG. 3. In some aspects, the network entity 502 may be another type of a network entity, a network node, or a network, such as those referenced and described herein. The UE 504 may be another type of a UE or a wireless communications device, such as those referenced and described herein.

MDT functionality may allow for the collection of UE-specific measurements. In some examples, the control plane architecture for NR may be utilized for MDT functionality. In accordance with some implementations, however, UTRAN and E-UTRAN may also be utilized MDT functionality.

At 506, the network entity 502 may initiate logged MDT procedures when the UE 504 is in the RRC Connected mode by sending a message referred to herein as a LoggedMeasurementConfiguration message to the UE 504. The LoggedMeasurementConfiguration message is an RRC message that may be used to configure the UE 504 to perform logging of measurement results when the UE 504 is operating in the RRC Idle mode or the RRC Inactive mode. Additionally, the LoggedMeasurementConfiguration message may transfer configuration parameters for MDT operation associated with carrying the measurements and future reporting.

The configuration parameters transferred by the LoggedMeasurementConfiguration message may include, for example, downlink pilot strength measurements, triggering information of logging events (e.g., event-based or periodic), and configuration of logging duration. Regarding the logging duration parameter, a timer may be used to indicate a time frame associated with the MDT measurements triggered by the LoggedMeasurementConfiguration message. The timer may be started upon reception of the the LoggedMeasurementConfiguration message.

The configuration parameters transferred by the LoggedMeasurementConfiguration message may also include, for example, configuration of logging area and configuration of a list of neighboring cells and/or frequencies. These parameters may provide specific information related to the MDT measurements to be performed by the UE 504. Certain configuration parameters may be optional in some implementations.

In some cases, the network entity 502 may utilize a UE capabilities indication or report from the UE 504 to select the UE 504 for logged MDT configuration and measurement reporting.

At 508, measurements for logged MDT reporting may be performed when the UE 504 is in an RRC Idle mode or an RRC Inactive mode. While in the RRC Idle mode or the RRC Inactive mode, the UE 504 may log measurements, for example, reference signal received power (RSRP), reference signal received quality (RSRQ), SSB index, etc., for signals received from the current cell on which the UE 504 is camped.

In some cases, the UE 504 may also log measurements for signals received from neighboring cell(s). In some implementations, to limit the impact on UE power consumption and processing of the UE 504, the measurements performed by the UE 504 for logged MDT measurement reports may rely (e.g., as much as practical) on measurements that are available to, and may be performed by, the UE 504 while operating in the RRC Idle state or RRC Inactive state.

The logged MDT reports generated by the UE 504 may include multiple events and measurements taken over time. In some implementations, the time interval for logged MDT measurement collection and reporting may be independent of one another, which may limit the impact on the UE battery consumption and network signaling load. The UE 504 continues to log until the UE memory reserved for MDT is full. When the LoggedMeasurementConfiguration message is received, a 48-hour timer for logged MDT reporting may start. For example, the UE 504 may flush any non-retrieved logged MDT measurements from the UE memory upon expiry of the 48-hour timer.

At 510, at some time after entering the RRC Idle mode or the RRC Inactive mode, for example, when the UE 504 has a reason to transition to the RRC Connected mode, the UE 504 may indicate availability of or report these logged MDT measurements. In some implementations, the UE 504 transitions to the RRC Connected mode irrespective of any configuration parameters transferred by the LoggedMeasurementConfiguration message. Additionally, the UE 504 may indicate the availability of a logged MDT measurement report by using one bit when switching to RRC Connected mode, for example, during an RRC Connection Establishment procedure.

At 512, the UE 504 may be requested by the network entity 502 to send the collected measurements via RRC signaling. For example, the network entity 502 may send a message referred to herein as a UEInformationRequest message to the UE 504.

At 514, upon receiving the UEInformationRequest message, the UE may include logged measurement entries in a logged MDT report and send the logged MDT report in a message referred to herein as a UEInformationResponse message to the network entity 502. In some cases, the logged measurement entries collected by the UE 504 may include a timestamp and/or location information. For example, location information may include detailed Global Navigation Satellite System (GNSS) location information, if available. However, in determining whether to provide detailed location information, the network entity 502 and/or the UE 504 may consider power consumption requirements on the UE 504 caused by operating the UE's positioning components.

In some cases, the logged measurement entries collected by the UE 504 may include coarse location information (e.g., RF fingerprints from different cells, etc.). In some cases, the logged measurement entries collected by the UE 504, and sent in the UEInformationResponse, may include sensor information, if configured and accessible by the UE 504.

### Example Signaling of Logged MDT Configurations and Measurement Reporting

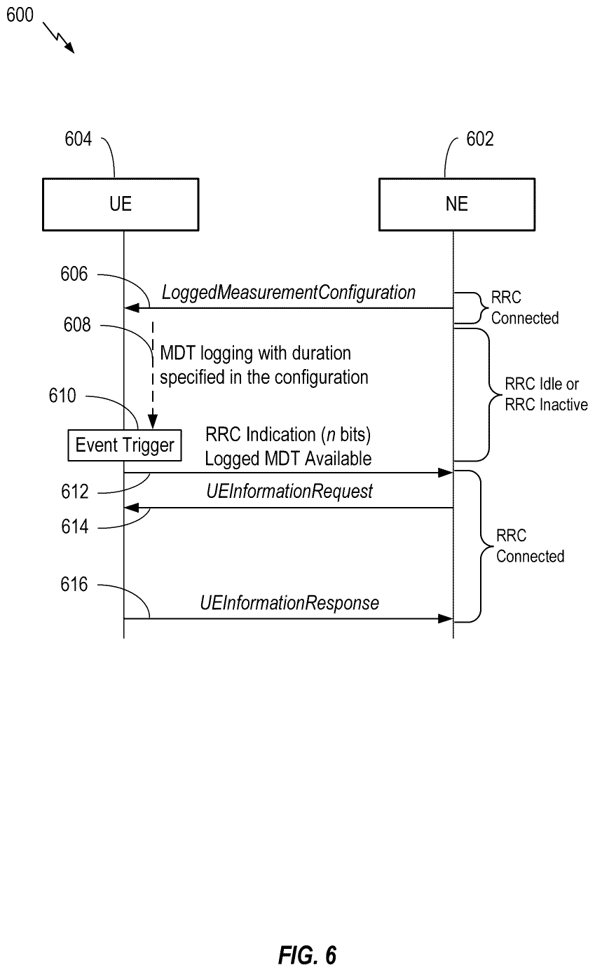

FIG. 6 depicts a second example communications signaling 600 for logged MDT configuration and measurement reporting. The second example communications signaling 600 may be between a network entity 602 and a UE 604. Various aspects related to logged MDT configurations and measurement reporting may be implemented using the framework depicted in the second example communications signaling 600.

In some aspects, the network entity 602 may be an example of the BS 102 depicted and described with respect to FIG. 1, the first network entity 300 or the second network entity 302 depicted and described with respect to FIG. 3, a disaggregated base station depicted and described with respect to FIG. 2. Similarly, the UE 604 may be an example of UE 104 depicted and described with respect to FIG. 1, or the UE 304 depicted and described with respect to FIG. 3. In some aspects, the network entity 602 may be another type of a network entity, a network node, or a network, such as those referenced and described herein. The UE 604 may be another type of a UE or a wireless communications device, such as those referenced and described herein.

At 606, the network entity 602 may send, and the UE 604 may receive, first signaling indicating one or more report triggering events for logged MDT measurement reporting. For example, the first signaling may provide configuration information (e.g., a logged MDT configuration) while the UE 604 is operating in the RRC connected state. In some examples, the configuration information may be RRC signaled as a LoggedMeasurementConfiguration message (or a similar information element or message) that includes the one or more report triggering events. In some examples, the UE 604 may receive all or part of the logged MDT configuration via MAC CE or DCI signaling. A report triggering event for logged MDT measurement reporting includes a condition that, when satisfied, causes the UE 604 to report (or initiate reporting of) a logged MDT measurement or report.

For example, the first signaling may provide configuration information indicating the one or more report triggering events for logged MDT measurement reporting. The UE 604 performs the MDT measurements in accordance with the configuration information while operating in an RRC Idle state or RRC Inactive state. Thus, the logged MDT reporting can be event-triggered based on an occurrence of the one or more report triggering events. A report triggering event that triggers the UE 604 to perform connection establishment procedures and transition to the RRC connected state in order to provide a logged MDT report is advantageous to the network when the logged MDT report includes time-sensitive information.

Various types of time-sensitive, logged MDT report triggering events may be configured in the one or more report triggering events, so as to trigger the UE 604 to exit an RRC Idle/Inactive state and enter the RRC connected state.

In some cases, one or more report triggering events may be associated with a network condition that is detectable by the UE 604 while the UE 604 is operating in an RRC idle state or an RRC inactive state. For example, there may be some events that the UE 604 can detect even when the UE 604 is not in the RRC connection state and actively communicating with the network entity 602 (or any other RAN network nodes). Detectable network conditions that may be used as report triggering events include outage conditions and overlapping coverage conditions.

For example, reports or indications of measurements availability can be triggered by a report triggering event when the UE 604 is experiencing poor network service (e.g., an outage condition) or poor network planning (e.g., an overlapping coverage condition). In some cases, an outage condition refers to the failure or unavailability of the network for wireless communications with the UE 604. In some cases, an overlapping coverage condition is satisfied if there is an area of the network in which excessive overlapping coverage exists, thereby causing interference between cells and and/or network energy inefficiencies.

For example, when the UE 604 is experiencing an outage or a signal level that does not satisfy a threshold (e.g., below an RSRP threshold), then the UE 604 may be triggered to exit an RRC Idle/Inactive state and enter the RRC connected state to provide an indication of logged MDT report availability.

Additionally, or alternatively, when the UE 604 is detecting excessive overlapping coverage (e.g., too many “good” beams/cells in a given location), the UE 604 may be triggered to exit an RRC Idle/Inactive state and enter the RRC connected state to provide an indication of logged MDT report availability. In some cases, the overlapping coverage condition may be determined based on a threshold being satisfied for a number of acceptable beams and/or cells. For example, if the UE 604 detects an RSRP measurement above an RSRP threshold for each beam of N number of beams (or cells), then a report triggering event may be triggered.

In some cases, the overlapping coverage condition may be determined based on detecting that at least one acceptable beam (or cell) of the N number of beams (or cells) is configured for a radio access technology (RAT) different from at least one other acceptable beam (or cell) of the N number of beams (or cells). In this manner, the network entity 602 may be able to ascertain whether there is relevant interference in that particular region and/or whether sufficient additional coverage is provided by other RATs.

In some cases, at least one report triggering event may be a time-based parameter for the network condition detectable by the UE 604. For example, the outage condition or overlapping coverage condition may be configured such that a report triggering event occurs when the corresponding condition lasts for greater than or equal to T seconds. In some cases, at least one report triggering event may be an occurrence-based parameter for the network condition detectable by the UE 604. For example, the outage condition or overlapping coverage condition may be configured such that a report triggering event occurs when the corresponding condition occurs at least N times during a T second time period. In some examples, the at least N times frequency component may be defined as a fraction of time (e.g., for T_{(Condition Experienced)} seconds during the T second time period).

In some cases, at least one report triggering event may be a network configuration parameter. For example, the outage condition or overlapping coverage condition may be configured for a particular frequency, a particular band (e.g., N28, N77, etc.), a frequency range (e.g., FR1, FR2, FR2-1, etc.), a list of cells, or a particular RAT.

For example, a first report triggering event may be a first time-based parameter (e.g., condition lasting for greater than or equal to T₁ seconds) for a network condition associated with a first network configuration parameter (e.g., FR1) and a second time-based parameter (e.g., condition lasting for greater than or equal to T₂ seconds) for the network condition associated with a second network configuration parameter (e.g., FR2). That is, for example, the one or more report triggering events may include different parameters for a same network condition (e.g., outage condition, overlapping coverage condition, etc.).

Additionally, or alternatively, the parameters associated with the one or more report triggering events (e.g., thresholds, timers, etc.) may be defined differently for different levels of mobility of the UE 604 (e.g., a first threshold, timers, etc. for a first speed and a second threshold, timers, etc. for a second speed different from the first speed).

In some cases, at least one report triggering event may be a UE operational parameter. For example, the outage condition, or overlapping coverage condition, may be configured for a particular geographical area. That is, for example, the UE 604 may consider or activate a particular report triggering event when the UE 604 detects it is positioned in that particular geographical area. UE operation parameters relate to conditions or situations associated with the UE 604 operating within the network.

Additionally, or alternatively, the UE 604 may receive second signaling indicating one or more logging triggering events for the logged MDT measurement reporting. In some examples, the second signaling may be provided concurrently with the first signaling and provide configuration information (e.g., a logged MDT configuration) while the UE 604 is operating in the RRC connected state. In some examples, the configuration information associated with both the first signaling and the second signaling may be RRC signaled as a LoggedMeasurementConfiguration message (or a similar information element or message) that includes the one or more report triggering events and the one or more logging triggering events. In some examples, the UE 604 may receive, all or part of, the logged MDT configuration (e.g., the first signaling, the second signaling, or both) via MAC CE or DCI signaling.

In some logged MDT reporting schemes, event-triggered logging (that is, commencing logging of MDT measurements based on a logging triggering event) may be based on either of two types of events occurring. First, when physical layer (e.g., L1) measurements fall below a given threshold for a given time to trigger, then MDT logging may be enabled. Additionally, or alternatively, if out-of-coverage detection is triggered, then MDT logging may be enabled.

In some aspects, however, the UE 604 may receive signaling from the network entity 602 that indicates logging triggering events for logged MDT measurement reporting that are different from these two types of events. For example, logging triggering events may indicate specific events or conditions for which the UE 604 is to be triggered to log MDT measurements while operating in the RRC Idle state or the RRC Inactive state.

In some examples, the specific events or conditions to trigger MDT logging by the UE 604 may be speed-based. Given the sensory information available at the UE 604, the UE 604 may trigger MDT logging if its own speed passes a speed threshold configured by the network entity 602. For example, an operator interested in the network coverage experienced by high-speed UEs may trigger configuration of such a report triggering event.

In some examples, the specific events or conditions to trigger MDT logging by the UE 604 may be signal strength-based events or conditions. For example, if the UE 604 is detecting a Wi-Fi/BT signal that is stronger than a threshold, this information may indicate that the UE 604 is located indoors. Thus, the UE 604 may be configured to trigger MDT logging based on determining that the UE 604 is indoors. In this manner, the network may analyze wireless network performance in various locations that are indoors. Additionally, or alternatively, the network may analyze wireless network performance in various locations that are outdoors.

In some examples, the specific events or conditions to trigger MDT logging by the UE 604 may be location-based. That is, for example, a logging triggering event may location-trigger MDT logging performed by the UE 604. In some cases, tracking area (TA) logging information may be included in the LoggedMeasurementConfiguration message. However, some logging triggering events may be configured to trigger MDT logging if the UE 604 is determined to be more precisely within (or in proximity to) a specific micro-area within a given TA. For example, the network may anticipate outage areas, poor performance areas, and/or network energy saving opportunity areas, and may define these various areas as specific micro-areas in logging triggering events.

As would be understood given the benefit of the disclosure, other sensory information may be configured to trigger MDT logging by the UE 604. For example, the UE 604 may be configured with an environmental-based logging triggering event (e.g., MDT logging triggered based on humidity thresholds, pressure thresholds, etc.).

In some examples, a delta-based logging triggering event may be configured for the UE 604. That is, for example, a UE 604 may provide delta measurement logging and reporting for MDT purposes. In some examples, the UE 604 may utilize a reference log for particular types of measurements to be performed during logged MDT measurement reporting. In some cases, rather than logging each measurement at a measurement opportunity configured for MDT reporting, the UE 604 may measure a parameter configured for logged MDT measurement reporting during the measurement opportunity. If the measurement is not within a configured threshold for the parameter, the UE 604 may log the deviation between the measurement and a reference value for the parameter in the reference log. In some cases, the network entity 602 may configure a reference value for the parameter that is a known (or expected) measurement for a particular type of measurement (e.g., RSRP, RSRQ, etc.) of interest to the network.

During the measurement opportunity, an amount of deviation (e.g., a delta value of a particular measurement) may be logged as part of the logged MDT measurement report. In some examples, the reference parameter in the reference log may correspond to a range of values, and the UE 604 may log the measurement for logged MDT reporting if the measurement during the measurement opportunity falls outside of the range.

The UE 604 may send UE capability information to the network entity 602. This UE capability information may indicate one or more logged MDT measurement reporting capabilities that may be performed by the UE 604. For example, some UEs may be capable of being configured with some report triggering events (e.g., signal strength-based report triggering events), but not other report based triggering events (e.g., speed-based report triggering events). Additionally, or alternatively, some UEs may be capable of being configured with some logging triggering events (e.g., speed-based and signal strength-based logging triggering events), but not other logging triggering events (e.g., environmental-based logging triggering events). In some cases, the first signaling, the second signaling, or both, may be responsive to the UE capability information.

For example, the network entity 602 may utilize a UE capabilities indication or report from the UE 604 to select the UE 604 as one of multiple UEs for logged MDT configuration and measurement reporting and eliminate some UEs (e.g., Redcap UEs) for a LoggedMeasurementConfiguration message (or a similar information element or message) that includes certain report triggering events and logging triggering events.

The UE 604 may be in the RRC connected state when receiving signaling for configuration information related to logged MDT configuration and measurement reporting. The UE 604 may release an RRC connected state (e.g., prior to performing the logged MDT measurements) with the network entity 602 subsequent to the receiving the signaling (e.g., first signaling. second signaling, etc.) from the network entity 602.

At 608, the UE 604 may perform one or more logged MDT measurements in accordance with the configuration provided by the LoggedMeasurementConfiguration message. The UE 604 performs these measurements while in an RRC idle state or an RRC inactive state. The logged MDT measurement report is generated based on these measurements. That is, for example, logged MDT measurements are performed when the UE 604 is in RRC idle or the RRC inactive mode. While the RRC Idle mode or the RRC Inactive mode, the UE 604 may log measurements, for example, RSRP, RSRQ, SSB index, etc., for signals received from the current cell on which the UE 604 is camped. Additionally, for example, the UE 604 may also log measurements for signals received from neighboring cell(s) based on a logged MDT configuration.

The UE 604 may perform a logged MDT measurement in response to the one or more logging triggering events being detected. In some examples, the UE 604 may be configured for and perform various logged MDT measurements related to network energy savings during off-peak hours, at which time there are fewer RRC connected UEs active in the network. In some examples, the network entity 602 and/or UE 604 may have some prior information (e.g., knowledge or expectation) regarding the coverage in an area. If such information is available to the UE 604, UE 604 may use it as a reference and log or report the measurements when there is a deviation from the prior knowledge or expectation, for example, when configured to do so. Thus, the UE 604 may provide delta measurement logging based on a logged MDT configuration. For example, the UE 604 may utilize a reference log for particular types of measurements associated with logged MDT measurement reporting and log any deviation, from the configured reference parameter(s) or value(s) in the reference log, that satisfies the configured threshold. The amount of deviation (e.g., a delta value of a particular measurement) may be logged as part of the logged MDT measurement report.

In some examples, the reference log may be based on historical measurements in a certain location. For example, if the current MDT measurements deviate from the historical measurements in the same location by a margin configured by the network entity 602, then the UE 604 may trigger logging.

In another example, the UE 604 may leverage a digital twin (e.g., virtual replica of certain network components that can use real-time data for predictive modeling) for event-triggered MDT logging and/or logged MDT reporting. For example, the UE 604 may have the digital twin of a certain area in the network. The UE 604 may compare predictions generated using the digital twin against the UE's actual measurements. Then, the UE 604 may log and/or report when the digital-twin-predicted measurement, as compared to the actual measurement, differs by a threshold configured by the network entity 602. That is, for example, the UE 604 may perform a logged MDT measurement in accordance with a digital-twin-exception-based logging triggering event.

At 610, the UE 604 may establish an RRC connected state with the network entity 602. In some cases, the RRC Connection Establishment procedure initiated by the UE 604 is based at least in part on a report triggering event. For example, when the UE 604 determines that one of the report triggering events has occurred, the UE 604 may exit the RRC idle state or RRC inactive state in which the UE 604 was operating, and immediately (or at the first opportunity) establish an active connection (e.g., enter an RRC connected state) with the network. For example, this RRC Connection Establishment procedure may be based solely on the report triggering event, occurring during a time period at which the UE 604 has no other reason for establishing an active connection with the network entity 602. As used herein, a time period may include a time window, a time duration, a specific time, a time after receiving signaling, etc.

In some examples, the network entity 602 may receive random access signaling from the UE 604. The random access signaling may be used in an attempt from the UE 604 to establish the RRC connected state with the network entity 602. That is, for example, the RRC connected state may be established in response to the UE 604 identifying that a report triggering event has occurred. By configuring report triggering events for the UE 604, more efficient logging of MDT measurements may be achieved relative to waiting until the UE 604 reconnects to the network for another reason.

At 612, the UE 604 may send first information to the network entity 602. The first information may include an indication of a logged MDT measurement report. The indication report may be sent by the UE 604 upon establishing the RRC connected state with the network entity 602. The first information may include an indication of a logged MDT measurement report (e.g., an indication of the type of logged MDT report and/or the measurement content therein). The network entity 602 may then decide whether obtain the logged MDT measurement report from the UE 604.

For example, the UE 604 may send an indication of the availability of the logged MDT measurements to the network entity 602 upon establishing the RRC connected state with the network. That is, for example, when UE 604 provides an indication of logged MDT measurements availability, the UE 604 may also provide an indication of the event that triggered the logging and/or reporting. The indication may inform the network entity 602 whether the event that triggered the indication of logged MDT measurements availability was an unexpected event or expected in the course of logged MDT reporting. Then, the network entity 602 may decide to collect the logged MDT measurements as soon as possible or defer the collection process to a later time (e.g., collecting measurements during non-peak hours).

In some logged MDT schemes, after the UE 604 logs measurements based on a configuration received from the network entity 602, the UE 604 may indicate the availability of such measurements through a one-bit indication via RRC signaling upon entering the RRC connected state with the network. The network then may decide when to collect those logged MDT measurements. In some cases, the UE 604 may continue to indicate the availability of measurements for a time window of 48 hours. Accordingly, report triggering events described herein may be applicable to these logged MDT schemes using the one-bit indication. The network entity 602 may then decide if certain logged MDT measurements (e.g., whether event-triggered or periodic) are timely and/or relevant to the operations in the network at that time.

In some examples, the first information may include an indication of the report triggering event (e.g., an n-bit indication) that triggered the logged MDT measurement report. This indication of the event may enable the network entity 602 to distinguish the event from other report triggering events that could have prompted the indication.

At 614, the UE 604 may receive, responsive to the first information, a message indicating whether the UE 604 should send the logged MDT measurement report. That is, upon receiving the indication informing the network entity 602 of additional information (e.g., report triggering, logging triggering, etc.), the network entity 602 may inform the UE 604 to discard the current logged MDT measurements (e.g., if the logged measurements are deemed not to be timely and/or relevant). Alternatively, the UE 604 may be requested by the network to send the collected measurements via RRC signaling. For example, the UE 604 may receive a UEInformationRequest message (or a similar information element or message) from the network entity 602.

In some examples, the UE 604 may receive an indication of a time period at which to send the logged MDT measurement report to the network entity 602. This report transmission indication may be responsive to the first information sent by the UE 604. For example, the indication of logged MDT measurements that the UE 604 sends to the network entity 602 may indicate an event or condition that triggered the logged MDT measurement report. The network entity 602 may then prioritize retrieval of the logged MDT measurement report based on the indication in the first information provided by the UE 604.

At 616, the UE 604 may send the logged MDT measurement report to the network entity 602. For example, based on information in the UEInformationRequest message (or a similar information element or message), the UE 604 may include a logged MDT measurement report in a UEInformationResponse (or a similar information element or message) to the network element. In some examples, the UE 604 may send the logged MDT measurement report immediately, or at a designated time period indicated by the network entity 602.

In some examples, the UE 604 may send second information associated with the logged MDT measurement report to the network entity 602. In some cases, the second information may indicate a delta value associated with one or more logged MDT measurements of the logged MDT measurement report. That is, for example, the UE 604 may provide delta measurement reporting to the network entity 602 based on a logged MDT configuration as described herein.

### Example Operations of a User Equipment

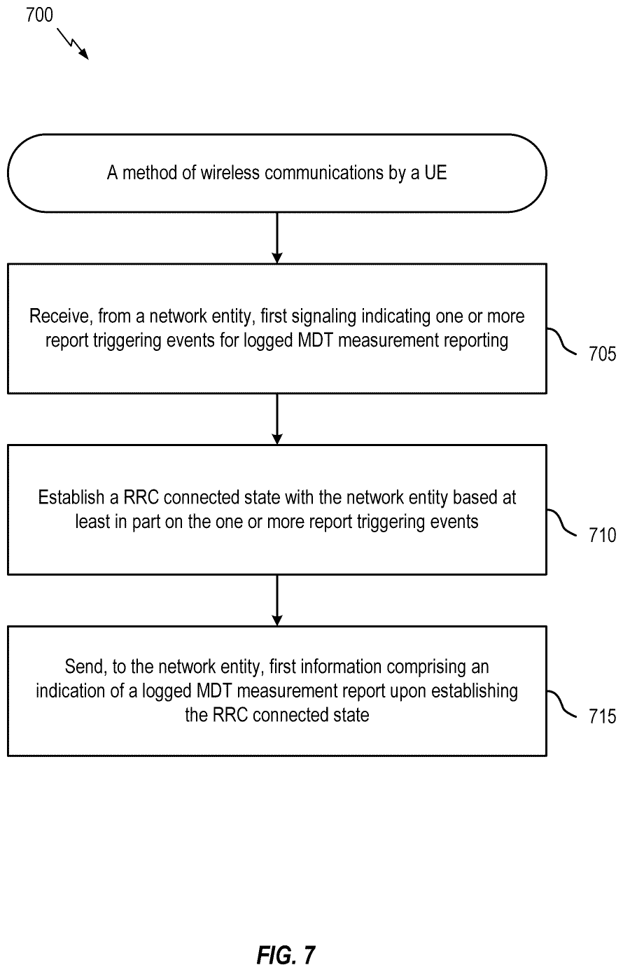

FIG. 7 shows a method 700 for wireless communications by a UE, such as UE 104 of FIG. 1 or UE 304 of FIG. 3.

Method 700 begins at block 705 with receiving, from a network entity, first signaling indicating one or more report triggering events for logged MDT measurement reporting, as illustrated for example at 606 of FIG. 6.

Method 700 then proceeds to block 710 with establishing a RRC connected state with the network entity based at least in part on the one or more report triggering events, as illustrated for example at 610 and 612 of FIG. 6.

Method 700 then proceeds to block 715 with sending, to the network entity, first information comprising an indication of a logged MDT measurement report upon establishing the RRC connected state, as illustrated for example at 612 of FIG. 6.

In some aspects, method 700 further includes receiving, from the network entity, second signaling indicating one or more logging triggering events for the logged MDT measurement reporting.

In some aspects, the one or more logging triggering events includes a delta-based logging triggering event.

In some aspects, method 700 further includes performing a logged MDT measurement in response to the one or more logging triggering events being detected.

In some aspects, the first information comprises an indication of an event, of the one or more report triggering events, that triggered the logged MDT measurement report.

In some aspects, method 700 further includes receiving, responsive to the first information, an indication of a time period at which to send the logged MDT measurement report.

In some aspects, method 700 further includes sending the logged MDT measurement report in accordance with the indication of the time period.

In some aspects, method 700 further includes sending, to the network entity, second information associated with the logged MDT measurement report, wherein the second information indicates a delta value associated with one or more logged MDT measurements of the logged MDT measurement report.

In some aspects, the one or more report triggering events are associated with a network condition detectable by the UE while in an RRC idle state or an RRC inactive state.

In some aspects, the network condition detectable by the UE is associated with at least one of an outage condition, or an overlapping coverage condition.

In some aspects, at least one report triggering event of the one or more report triggering events includes at least one of a time-based parameter for the network condition detectable by the UE, or an occurrence-based parameter for the network condition detectable by the UE.

In some aspects, at least one report triggering event of the one or more report triggering events includes at least one of a network configuration parameter or a UE operational parameter.

In some aspects, block 710 includes establishing the RRC connected state in response to identifying the one or more report triggering events.

In some aspects, method 700 further includes releasing a first RRC connected state with the network entity subsequent to the receiving the first signaling.

In some aspects, method 700 further includes performing, while in an RRC idle state or an RRC inactive state, one or more logged MDT measurements, wherein the logged MDT measurement report is based at least in part on the one or more logged MDT measurements.

In some aspects, method 700 further includes sending, to the network entity, UE capability information associated with the logged MDT measurement reporting, wherein the first signaling is responsive to the UE capability information.

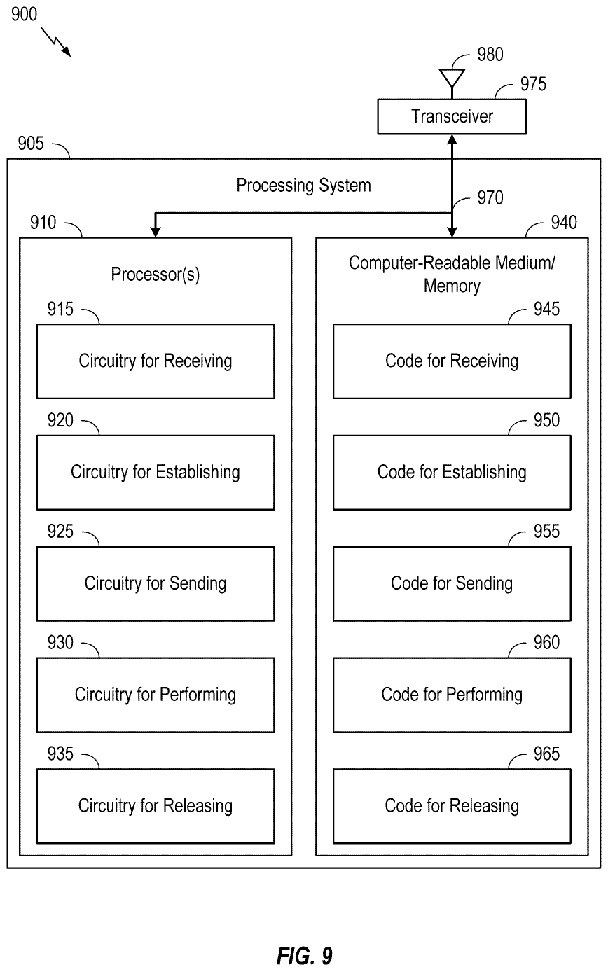

In some aspects, method 700, or any aspect related to it, may be performed by an apparatus, such as communications device 900 of FIG. 9, which includes various components operable, configured, or adapted to perform the method 700. Communications device 900 is described below in further detail.

Note that FIG. 7 is just one example of a method, and other methods including fewer, additional, or alternative operations are possible consistent with this disclosure.

### Example Operations of a Network Entity

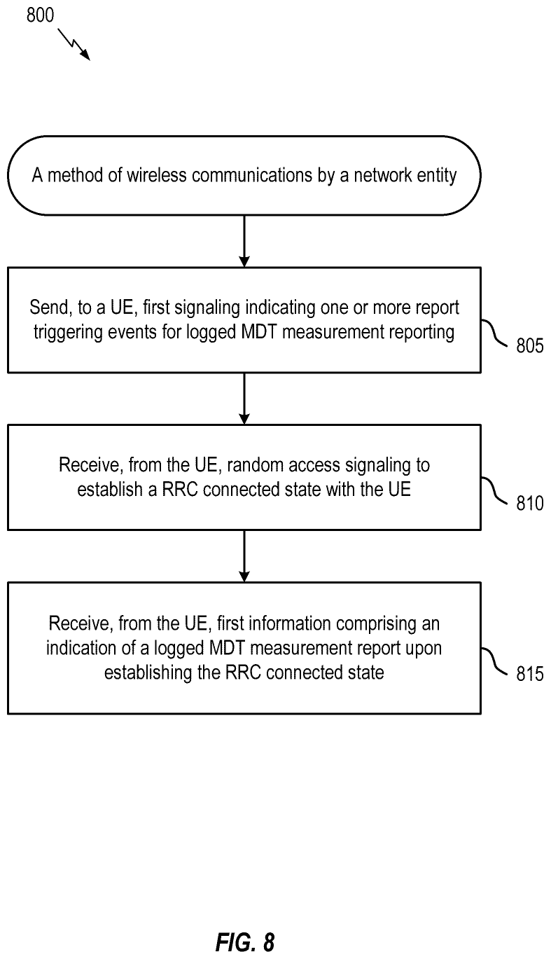

FIG. 8 shows a method 800 for wireless communications by a network entity, such as BS 102 of FIG. 1, a first network entity 300 or second network entity 302 of FIG. 3, or a disaggregated base station as discussed with respect to FIG. 2.

Method 800 begins at block 805 with sending, to a UE, first signaling indicating one or more report triggering events for logged MDT measurement reporting, as illustrated for example at 606 of FIG. 6.

Method 800 then proceeds to block 810 with receiving, from the UE, random access signaling to establish a RRC connected state with the UE, as illustrated for example at 612 of FIG. 6.

Method 800 then proceeds to block 815 with receiving, from the UE, first information comprising an indication of a logged MDT measurement report upon establishing the RRC connected state, as illustrated for example at 612 of FIG. 6.

In certain aspects, method 800 further includes sending, to the UE, second signaling indicating one or more logging triggering events for the logged MDT measurement reporting.

In some aspects, the one or more logging triggering events includes a delta-based logging triggering event.

In some aspects, the first information comprises an indication of an event, of the one or more report triggering events, that triggered the logged MDT measurement report.

In certain aspects, method 800 further includes sending, responsive to the first information, an indication of a time period at which to send the logged MDT measurement report.

In certain aspects, method 800 further includes receiving the logged MDT measurement report in accordance with the indication of the time period.

In certain aspects, method 800 further includes receiving, from the UE, second information associated with the logged MDT measurement report, wherein the second information indicates a delta value associated with one or more logged MDT measurements of the logged MDT measurement report.

In some aspects, the one or more report triggering events are associated with a network condition detectable by the UE while in an RRC idle state or an RRC inactive state.

In some aspects, the network condition detectable by the UE is associated with at least one of an outage condition, or an overlapping coverage condition.

In some aspects, at least one report triggering event of the one or more report triggering events includes at least one of a time-based parameter for the network condition detectable by the UE, or an occurrence-based parameter for the network condition detectable by the UE.

In some aspects, at least one report triggering event of the one or more report triggering events includes at least one of a network configuration parameter or a UE operational parameter.

In certain aspects, method 800 further includes receiving, from the UE, UE capability information associated with the logged MDT measurement reporting, wherein the first signaling is responsive to the UE capability information.

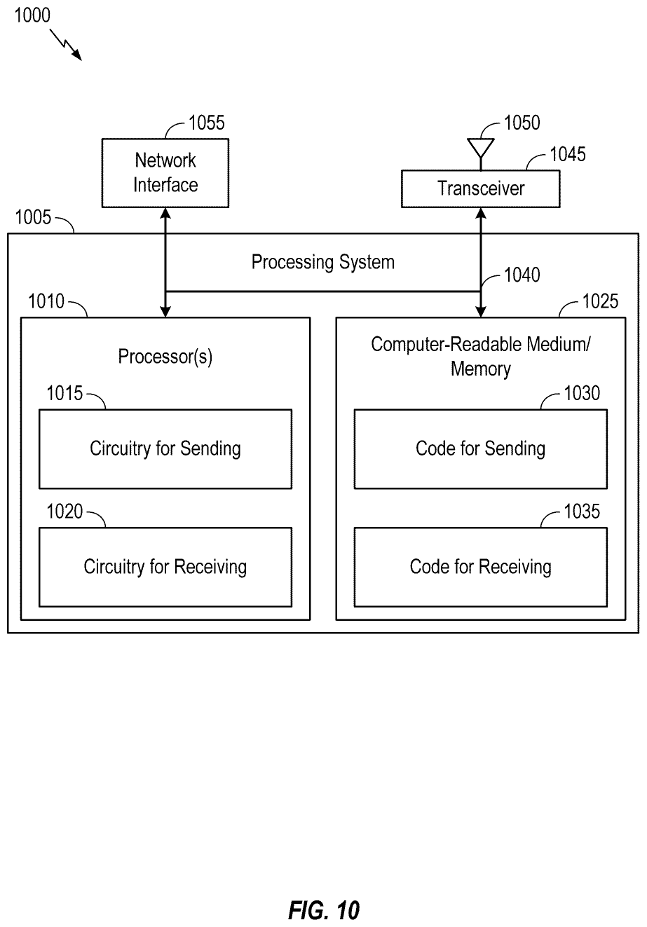

In some aspects, method 800, or any aspect related to it, may be performed by an apparatus, such as communications device 1000 of FIG. 10, which includes various components operable, configured, or adapted to perform the method 800. Communications device 1000 is described below in further detail.

Note that FIG. 8 is just one example of a method, and other methods including fewer, additional, or alternative operations are possible consistent with this disclosure.

### Example Communications Devices

FIG. 9 depicts aspects of an example communications device 900 configured for wireless communications. In some aspects, communications device 900 is a user equipment, such as UE 104 described above with respect to FIG. 1 or UE 304 described with respect to FIG. 3.

The communications device 900 includes a processing system 905 coupled to a transceiver 975 (e.g., a transmitter and/or a receiver). The transceiver 975 is configured to transmit and receive signals for the communications device 900 via an antenna 980, such as the various signals as described herein. The processing system 905 may be configured to perform processing functions for the communications device 900, including processing signals received and/or to be transmitted by the communications device 900.

The processing system 905 includes one or more processors 910 and a computer-readable medium/memory 940. In various aspects, the one or more processors 910 may be representative of the one or more processors 318 described with respect to FIG. 3. The one or more processors 910 are coupled to a computer-readable medium/memory 940 via a bus 970. In some aspects, the computer-readable medium/memory 940 may be representative of the one or more memories 320 described with respect to FIG. 3. The computer-readable medium/memory 940 is a non-transitory computer-readable medium/memory. In certain aspects, the computer-readable medium/memory 940 is configured to store instructions (e.g., computer-executable code), that when executed by the one or more processors 910, cause the one or more processors 910 to perform the method 700 described with respect to FIG. 7, or any aspect related to it, including any operations described in relation to FIG. 7. Note that reference to a processor performing a function of communications device 900 may include one or more processors performing that function of communications device 900, such as in a distributed fashion.

In the depicted example, computer-readable medium/memory 940 stores code (e.g., executable instructions), including code for receiving 945, code for establishing 950, code for sending 955, code for performing 960, and code for releasing 965. Processing of the code 945-965 may enable and cause the communications device 900 to perform the method 700 described with respect to FIG. 7, or any aspect related to it. For instance, in some aspects, code for receiving 945 includes code for receiving, from a network entity, first signaling indicating one or more report triggering events for logged MDT measurement reporting. In some aspects, code for establishing 950 includes code for establishing an RRC connected state with the network entity based at least in part on the one or more report triggering events. In some aspects, code for sending 955 includes code for sending, to the network entity, first information comprising an indication of a logged MDT measurement report upon establishing the RRC connected state.

The one or more processors 910 include circuitry configured to implement (e.g., execute) the code stored in the computer-readable medium/memory 940, including circuitry for receiving 915, circuitry for establishing 920, circuitry for sending 925, circuitry for performing 930, and circuitry for releasing 935. Processing with circuitry 915-935 may enable and cause the communications device 900 to perform the method 700 described with respect to FIG. 7, or any aspect related to it. For instance, in some aspects, circuitry for receiving 915 includes circuitry for receiving, from a network entity, first signaling indicating one or more report triggering events for logged MDT measurement reporting. In some aspects, circuitry for establishing 920 includes circuitry for establishing an RRC connected state with the network entity based at least in part on the one or more report triggering events. In some aspects, circuitry for sending 925 includes circuitry for sending, to the network entity, first information comprising an indication of a logged MDT measurement report upon establishing the RRC connected state.

More generally, means for communicating, transmitting, sending or outputting for transmission may include the one or more transceivers 324, one or more antenna 322 and/or processing system 316 of the UE 304 illustrated in FIG. 3, transceiver 975 and/or antenna 980 of the communications device 900 in FIG. 9, and/or one or more processors 910 of the communications device 900 in FIG. 9. Means for communicating, receiving or obtaining may include the one or more transceivers 324, one or more antennas 322, and/or processing system 316 of the UE 304 illustrated in FIG. 3, transceiver 975 and/or antenna 980 of the communications device 900 in FIG. 9, and/or one or more processors 910 of the communications device 900 in FIG. 9.

FIG. 10 depicts aspects of an example communications device configured for wireless communications. In some aspects, communications device 1000 is a network entity, such as BS 102 of FIG. 1, first network entity 300 or second network entity 302 of FIG. 3, or a disaggregated base station as discussed with respect to FIG. 2.

The communications device 1000 includes a processing system 1005 coupled to a transceiver 1045 (e.g., a transmitter and/or a receiver) and/or a network interface 1055. The transceiver 1045 is configured to transmit and receive signals for the communications device 1000 via an antenna 1050, such as the various signals as described herein. The network interface 1055 is configured to obtain and send signals for the communications device 1000 via communications link(s), such as a backhaul link, midhaul link, and/or fronthaul link as described herein, such as with respect to FIG. 2. The processing system 1005 may be configured to perform processing functions for the communications device 1000, including processing signals received and/or to be transmitted by the communications device 1000.

The processing system 1005 includes one or more processors 1010 and a computer-readable medium/memory 1025. In various aspects, one or more processors 1010 may be representative of the one or more processors 308, as described with respect to FIG. 3. The one or more processors 1010 are coupled to the computer-readable medium/memory 1025 via a bus 1040. In certain aspects, the computer-readable medium/memory 1025 is configured to store instructions (e.g., computer-executable code), including code 1030 and 1035, that when executed by the one or more processors 1010, cause the one or more processors 1010 to perform the method 800 described with respect to FIG. 8, or any aspect related to it, including any operations described in relation to FIG. 8. The computer-readable medium/memory 1025 is a non-transitory computer-readable medium/memory. Note that reference to a processor of communications device 1000 performing a function may include one or more processors of communications device 1000 performing that function, such as in a distributed fashion.

In the depicted example, the computer-readable medium/memory 1025 stores code (e.g., executable instructions), including code for sending 1030 and code for receiving 1035. Processing of the code 1030 and 1035 may enable and cause the communications device 1000 to perform the method 800 described with respect to FIG. 8, or any aspect related to it. For instance, in some aspects, code for sending 1030 includes code for sending, to a UE, first signaling indicating one or more report triggering events for logged MDT measurement reporting. In some aspects, code for receiving 1035 includes code for receiving, from the UE, random access signaling to establish an RRC connected state with the UE. In some aspects, code for receiving 1035 includes code for receiving, from the UE, first information comprising an indication of a logged MDT measurement report upon establishing the RRC connected state.

The one or more processors 1010 include circuitry configured to implement (e.g., execute) the code stored in the computer-readable medium/memory 1025, including circuitry for sending 1015 and circuitry for receiving 1020. Processing with circuitry 1015 and 1020 may enable and cause the communications device 1000 to perform the method 800 described with respect to FIG. 8, or any aspect related to it. For instance, in some aspects, circuitry for sending 1015 includes circuitry for sending, to a UE, first signaling indicating one or more report triggering events for logged MDT measurement reporting. In some aspects, circuitry for receiving 1020 includes circuitry for receiving, from the UE, random access signaling to establish an RRC connected state with the UE. In some aspects, circuitry for receiving 1020 includes circuitry for receiving, from the UE, first information comprising an indication of a logged MDT measurement report upon establishing the RRC connected state.

Various components of the communications device 1000 may provide means for performing the method 800 described with respect to FIG. 8, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1045, antenna 1050, and/or network interface 1055 of the communications device 1000 in FIG. 10, and/or one or more processors 1010 of the communications device 1000 in FIG. 10. Means for communicating, receiving or obtaining may include the one or more transceivers 312, one or more antennas 314, and/or processing system 306 of the first network entity 300 or the second network entity 302 illustrated in FIG. 3, transceiver 1045, antenna 1050, and/or network interface 1055 of the communications device 1000 in FIG. 10, and/or one or more processors 1010 of the communications device 1000 in FIG. 10.

### Example Clauses

Implementation examples are described in the following numbered clauses:
Clause 1: A method of wireless communications by a UE, comprising: receiving, from a network entity, first signaling indicating one or more report triggering events for logged MDT measurement reporting; establishing a RRC connected state with the network entity based at least in part on the one or more report triggering events; and sending, to the network entity, first information comprising an indication of a logged MDT measurement report upon establishing the RRC connected state.
Clause 2: The method of Clause 1, further comprising: receiving, from the network entity, second signaling indicating one or more logging triggering events for the logged MDT measurement reporting.
Clause 3: The method of Clause 2, wherein the one or more logging triggering events includes a delta-based logging triggering event.
Clause 4: The method of Clause 2, further comprising performing a logged MDT measurement in response to the one or more logging triggering events being detected.
Clause 5: The method of any one of Clauses 1-4, wherein the first information comprises an indication of an event, of the one or more report triggering events, that triggered the logged MDT measurement report.
Clause 6: The method of any one of Clauses 1-5, further comprising: receiving, responsive to the first information, an indication of a time period at which to send the logged MDT measurement report; and sending the logged MDT measurement report in accordance with the indication of the time period.
Clause 7: The method of any one of Clauses 1-6, further comprising: sending, to the network entity, second information associated with the logged MDT measurement report, wherein the second information indicates a delta value associated with one or more logged MDT measurements of the logged MDT measurement report.
Clause 8: The method of any one of Clauses 1-7, wherein the one or more report triggering events are associated with a network condition detectable by the UE while in an RRC idle state or an RRC inactive state.
Clause 9: The method of Clause 8, wherein the network condition detectable by the UE is associated with at least one of an outage condition, or an overlapping coverage condition.
Clause 10: The method of Clause 8, wherein at least one report triggering event of the one or more report triggering events includes at least one of a time-based parameter for the network condition detectable by the UE, or an occurrence-based parameter for the network condition detectable by the UE.
Clause 11: The method of any one of Clauses 1-10, wherein at least one report triggering event of the one or more report triggering events includes at least one of a network configuration parameter or a UE operational parameter.
Clause 12: The method of any one of Clauses 1-11, wherein establishing the RRC connected state based at least in part on the one or more report triggering events comprises establishing the RRC connected state in response to identifying the one or more report triggering events.
Clause 13: The method of any one of Clauses 1-12, further comprising: releasing a first RRC connected state with the network entity subsequent to the receiving the first signaling; and performing, while in an RRC idle state or an RRC inactive state, one or more logged MDT measurements, wherein the logged MDT measurement report is based at least in part on the one or more logged MDT measurements.
Clause 14: The method of any one of Clauses 1-13, further comprising: sending, to the network entity, UE capability information associated with the logged MDT measurement reporting, wherein the first signaling is responsive to the UE capability information.
Clause 15: A method of wireless communications by a network entity, comprising: sending, to a UE, first signaling indicating one or more report triggering events for logged MDT measurement reporting; receiving, from the UE, random access signaling to establish a RRC connected state with the UE; and receiving, from the UE, first information comprising an indication of a logged MDT measurement report upon establishing the RRC connected state.
Clause 16: The method of Clause 15, further comprising: sending, to the UE, second signaling indicating one or more logging triggering events for the logged MDT measurement reporting.
Clause 17: The method of Clause 16, wherein the one or more logging triggering events includes a delta-based logging triggering event.
Clause 18: The method of any one of Clauses 15-17, wherein the first information comprises an indication of an event, of the one or more report triggering events, that triggered the logged MDT measurement report.
Clause 19: The method of any one of Clauses 15-18, further comprising: sending, responsive to the first information, an indication of a time period at which to send the logged MDT measurement report; and receiving the logged MDT measurement report in accordance with the indication of the time period.
Clause 20: The method of any one of Clauses 15-19, further comprising: receiving, from the UE, second information associated with the logged MDT measurement report, wherein the second information indicates a delta value associated with one or more logged MDT measurements of the logged MDT measurement report.
Clause 21: The method of any one of Clauses 15-20, wherein the one or more report triggering events are associated with a network condition detectable by the UE while in an RRC idle state or an RRC inactive state.
Clause 22: The method of Clause 21, wherein the network condition detectable by the UE is associated with at least one of an outage condition, or an overlapping coverage condition.
Clause 23: The method of Clause 21, wherein at least one report triggering event of the one or more report triggering events includes at least one of a time-based parameter for the network condition detectable by the UE, or an occurrence-based parameter for the network condition detectable by the UE.
Clause 24: The method of any one of Clauses 15-23, wherein at least one report triggering event of the one or more report triggering events includes at least one of a network configuration parameter or a UE operational parameter.
Clause 25: The method of any one of Clauses 15-24, further comprising: receiving, from the UE, UE capability information associated with the logged MDT measurement reporting, wherein the first signaling is responsive to the UE capability information.
Clause 26: One or more apparatuses, comprising: one or more memories comprising executable instructions; and one or more processors configured to execute the executable instructions and cause the one or more apparatuses to perform a method in accordance with any one of Clauses 1-25.
Clause 27: One or more apparatuses configured for wireless communications, comprising: one or more memories; and one or more processors, coupled to the one or more memories, configured to cause the one or more apparatuses to perform a method in accordance with any one of Clauses 1-25.
Clause 28: One or more apparatuses configured for wireless communications, comprising: one or more memories; and one or more processors, coupled to the one or more memories, configured to perform a method in accordance with any one of Clauses 1-25.
Clause 29: One or more apparatuses, comprising means for performing a method in accordance with any one of Clauses 1-25.
Clause 30: One or more non-transitory computer-readable media comprising executable instructions that, when executed by one or more processors of one or more apparatuses, cause the one or more apparatuses to perform a method in accordance with any one of Clauses 1-25.
Clause 31: One or more computer program products embodied on one or more computer-readable storage media comprising code for performing a method in accordance with any one of Clauses 1-25.
Clause 32: One or more apparatuses configured for wireless communications, comprising: a processing system that includes one or more processors and one or more memories coupled with the one or more processors, the processing system configured to cause the one or more apparatuses to perform a method in accordance with any one of Clauses 1-25.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
receive, from a network entity, first signaling indicating one or more report triggering events for logged minimization of drive test (MDT) measurement reporting;
establish a radio resource control (RRC) connected state with the network entity based at least in part on the one or more report triggering events; and
send, to the network entity, first information comprising an indication of a logged MDT measurement report upon establishing the RRC connected state.

2. The apparatus of claim 1, wherein the processing system is further configured to cause the UE to:
receive, from the network entity, second signaling indicating one or more logging triggering events for the logged MDT measurement reporting.

3. The apparatus of claim 2, wherein the one or more logging triggering events includes a delta-based logging triggering event.

4. The apparatus of claim 2, wherein the processing system is further configured to cause the UE to:
perform a logged MDT measurement in response to the one or more logging triggering events being detected.

5. The apparatus of claim 1, wherein the first information comprises an indication of an event, of the one or more report triggering events, that triggered the logged MDT measurement report.

6. The apparatus of claim 1, wherein the processing system is further configured to cause the UE to:
receive, responsive to the first information, an indication of a time period at which to send the logged MDT measurement report; and
send the logged MDT measurement report in accordance with the indication of the time period.

7. The apparatus of claim 1, wherein the processing system is further configured to cause the UE to:
send, to the network entity, second information associated with the logged MDT measurement report, wherein the second information indicates a delta value associated with one or more logged MDT measurements of the logged MDT measurement report.

8. The apparatus of claim 1, wherein the one or more report triggering events are associated with a network condition detectable by the UE while in an RRC idle state or an RRC inactive state.

9. The apparatus of claim 8, wherein the network condition detectable by the UE is associated with at least one of an outage condition, or an overlapping coverage condition.

10. The apparatus of claim 8, wherein at least one report triggering event of the one or more report triggering events includes at least one of a time-based parameter for the network condition detectable by the UE, or an occurrence-based parameter for the network condition detectable by the UE.

11. The apparatus of claim 1, wherein at least one report triggering event of the one or more report triggering events includes at least one of a network configuration parameter or a UE operational parameter.

12. The apparatus of claim 1, wherein to cause the UE to establish the RRC connected state based at least in part on the one or more report triggering events, the processing system is configured to cause the UE to establish the RRC connected state in response to identifying the one or more report triggering events.

13. The apparatus of claim 1, wherein the processing system is further configured to cause the UE to:
release a first RRC connected state with the network entity subsequent to the receiving the first signaling; and
perform, while in an RRC idle state or an RRC inactive state, one or more logged MDT measurements, wherein the logged MDT measurement report is based at least in part on the one or more logged MDT measurements.

14. The apparatus of claim 1, wherein the processing system is further configured to cause the UE to:
send, to the network entity, UE capability information associated with the logged MDT measurement reporting, wherein the first signaling is responsive to the UE capability information.

15. An apparatus for wireless communications, comprising a processing system that includes one or more processors and one or more memories coupled with the one or more processors, the processing system configured to cause a network entity to:
send, to a user equipment (UE), first signaling indicating one or more report triggering events for logged minimization of drive test (MDT) measurement reporting;
receive, from the UE, random access signaling to establish a radio resource control (RRC) connected state with the UE; and
receive, from the UE, first information comprising an indication of a logged MDT measurement report upon establishing the RRC connected state.

16. The apparatus of claim 15, wherein the processing system is further configured to cause the network entity to:
send, to the UE, second signaling indicating one or more logging triggering events for the logged MDT measurement reporting.

17. The apparatus of claim 16, wherein the one or more logging triggering events includes a delta-based logging triggering event.

18. The apparatus of claim 15, wherein the first information comprises an indication of an event, of the one or more report triggering events, that triggered the logged MDT measurement report.

19. The apparatus of claim 15, wherein the processing system is further configured to cause the network entity to:
send, responsive to the first information, an indication of a time period at which to send the logged MDT measurement report; and
receive the logged MDT measurement report in accordance with the indication of the time period.

20. A method of wireless communications by a user equipment (UE), comprising:
receiving, from a network entity, first signaling indicating one or more report triggering events for logged minimization of drive test (MDT) measurement reporting;
establishing a radio resource control (RRC) connected state with the network entity based at least in part on the one or more report triggering events; and
sending, to the network entity, first information comprising an indication of a logged MDT measurement report upon establishing the RRC connected state.
